(19) United States
(12) Patent Application Publication
(10) Pub. No.: US 2023/0083917 A1
(43) Pub. Date: Mar. 16, 2023

(54) HOLDING DEVICE FOR A BLANK

(71) Applicant: Ivoclar Vivadent AG, Schaan (LI)

(72) Inventor: Andreas HABIT, Tschagguns (AT)

(21) Appl. No.: 17/931,999

(22) Filed: Sep. 14, 2022

(30) Foreign Application Priority Data
Sep. 16, 2021 (EP) 21197107.2
May 26, 2022 (EP) 22175639.8

(51) Int. Cl. A61C 13/12; B23Q 3/06

(52) U.S. Cl. CPC A61C 13/12; B23Q 3/062; B23Q 2703/10

(57) ABSTRACT

A holding device (100) for a blank (200), having a first holding element (101-1) for inserting the blank (200); and a second holding element (101-2) for clamping the blank (200), which is lockable to the first holding element (101-1) by a rotational movement.

### CROSS-REFERENCE TO RELATED APPLICATIONS

This application claims priority to European patent application No. 21197107.2 filed on Sep. 16, 2021, and European patent application No. 22175639.8 of filed on May 26, 2022, which disclosures are incorporated herein by reference in their entirety.

### TECHNICAL FIELD

The present invention relates to a holding device for a blank, an auxiliary tool for opening the holding device and a method for holding the blank.

### BACKGROUND

During the daily use of dental milling machines, which process disc-shaped blanks, so-called circular blanks, material changes (loading processes) are required on a regular basis. During these processes, the blank is removed from a workpiece holder and replaced with a new blank. This process varies depending on the dental milling unit and the manufacturer. Since these operations require user interaction, they should be kept as simple and time-saving as possible. US 20160206410 is directed to a holding apparatus for a dental workpiece and hereby incorporated by reference in its entirety.

To unlock today's holding devices for milling blanks, four screws are currently loosened so that a clamping ring can subsequently be removed and the blank can be replaced. The clamping ring is then reinserted, the screws are applied by hand and tightened to a specified torque. This process is time-consuming and requires dexterity, tools and attention.

### SUMMARY

It is therefore the technical object of the present invention to simplify and accelerate the insertion of a blank into a holding device.

This technical object is solved by subject matter according to the independent claims. Technically advantageous embodiments are the subject of the dependent claims, the description and the drawings.

According to a first aspect, the technical problem is solved by a holding device for a blank, having a first holding element for inserting the blank; and a second holding element for clamping the blank, which can be locked to the first holding element by a rotary movement. The holding device saves time when clamping and unclamping the blank. In addition, the blank is held stably between the two holding elements.

In a technically advantageous embodiment of the holding device, the second holding element is formed by an open or closed ring. This provides, for example, the technical advantage that the blank can be fixed by a rotational or rotary movement. The ring can be manufactured in a simple manner.

In a further technically advantageous embodiment of the holding device, the ring comprises guide sections projecting radially inwards or outwards. The guide sections may be formed by pins. The guide sections can project radially in a sector-shaped manner. This achieves, for example, the technical advantage that the guide sections can be supported on corresponding undercuts in the first holding element.

In a further technically advantageous embodiment of the holding device, the guide sections are arranged on arms that extend in the axial direction of the second holding element. This achieves, for example, the technical advantage that the blank can be clamped over a large span.

In a further technically advantageous embodiment of the holding device, the radially protruding guide sections each comprise a spring section for generating a clamping force on the blank in the direction of the first holding element. This achieves, for example, the technical advantage that blanks can be inserted into the holding device with a predetermined clamping force.

In a further technically advantageous embodiment of the holding device, the guide sections extend over the undercuts. This also achieves the technical advantage, for example, that the guide sections can be supported on the undercuts.

In a further technically advantageous embodiment of the holding device, the first or second holding element comprises a stop element for limiting the rotational movement. This achieves, for example, the technical advantage that over-rotation of the second holding element is prevented and the correct seating of the ring is predetermined by the stop.

In a further technically advantageous embodiment of the holding device, the first holding element comprises at least one spring element for exerting a clamping force on a guide section of the second holding element, or the second holding element comprises at least one spring element for exerting a clamping force on a guide section of the first holding element. This achieves, for example, the technical advantage that the blank can be firmly clamped between the holding elements.

In a further technically advantageous embodiment of the holding device, the spring element is formed by a leaf spring. This has the technical advantage, for example, that the spring elements can be manufactured with little effort.

In a further technically advantageous embodiment of the holding device, the first or second holding element comprises at least one recess for guiding the guide section through. This achieves, for example, the technical advantage that the guide sections can be guided to the opposite side of the opposite holding element and interlocking fastening between the holding elements is made possible.

In a further technically advantageous embodiment of the holding device, the leaf spring is v-shaped. This achieves, for example, the technical advantage that a high clamping force can be generated for clamping the blank.

In a further technically advantageous embodiment of the holding device, one side of the v-shaped leaf spring rests against the first holding element. This achieves, for example, the technical advantage that good force transmission takes place between the holding elements.

In a further technically advantageous embodiment of the holding device, the spring elements are arranged on the side of the first holding element facing away from the second holding element. This achieves, for example, the technical advantage that the blank is surrounded by the holding elements and damage is avoided.

In a further technically advantageous embodiment of the holding device the first holding element comprises undercuts for supporting the spring sections of the second holding element in the axial direction. This provides, for example, the technical advantage of achieving good fastening of the first and second holding elements.

In a further technically advantageous embodiment of the holding device, the undercuts are arranged around the workpiece receptacle. This achieves, for example, the technical advantage that a uniform distribution of force can be exerted on the blank.

In a further technically advantageous embodiment of the holding device, the first holding element comprises a ball thrust piece, a spring and groove system or an adapter piece for engaging in the blank. This achieves, for example, the technical advantage that necessary adjustments and positioning can be carried out in a simple manner.

In a further technically advantageous embodiment of the holding device, the first holding element comprises a locking element for locking the second holding element in a closed position. This provides, for example, the technical advantage of preventing unintentional release or opening of the holding device.

In a further technically advantageous embodiment of the holding device, the first holding element and/or the second holding element are formed from a glass fiber reinforced material. The holding device can then comprise a radio chip (RFID—Radio-Frequency Identification). This provides, for example, the technical advantage that radio waves can pass through the holding device. Despite this, the holding elements have a high level of stability.

According to a second aspect, the technical object is solved by an auxiliary tool for opening a holding device comprising at least one engagement element for engaging a hole or a groove of the second holding element. This achieves, for example, the technical advantage that the blank can be clamped quickly and with a great clamping force in the holding device.

According to a third aspect, the technical object is solved by a method for holding a blank, comprising the steps of inserting the blank into a first holding element; and clamping the blank by a rotational movement of a second holding element lockable to the first holding element. Thereby, the same technical advantages are achieved as by the holding device according to the first aspect.

In a technically advantageous embodiment of the process, a clamping force is generated on the blank in the direction of the first holding element. This achieves, for example, the technical advantage that the blank can be reliably clamped in the holding device.

In a further technically advantageous embodiment of the process, the spring sections of the second holding element are supported on undercuts of the first holding element or radially inwardly or outwardly projecting guide sections of the first or second holding element are supported on spring elements of the first or second holding element. This achieves, for example, the technical advantage that the blank can be firmly clamped between the holding elements.

### BRIEF DESCRIPTION OF THE DRAWINGS

Examples of embodiments of the invention are shown in the drawings and will be described in more detail below.

FIG. 1 shows a composite holding device comprising a blank, a first holding element and a second holding element;

FIG. 2 shows a view of a first holding element of a holding device;

FIG. 3 shows a view of a second holding element of a holding device;

FIG. 4 shows a view of a blank;

FIG. 5 shows a holding device with an auxiliary tool for opening the holding device;

FIG. 6 shows a further view of the holding device with a movable latch element;

FIG. 7 shows a secondary locking of the holding device;

FIG. 8 shows a block diagram of a method for holding a blank;

FIG. 9 another embodiment of the holding device;

FIG. 10 a view of a second holding element of the holding device; and

FIG. 11 a view of a first holding element of the holding device.

### DETAILED DESCRIPTION

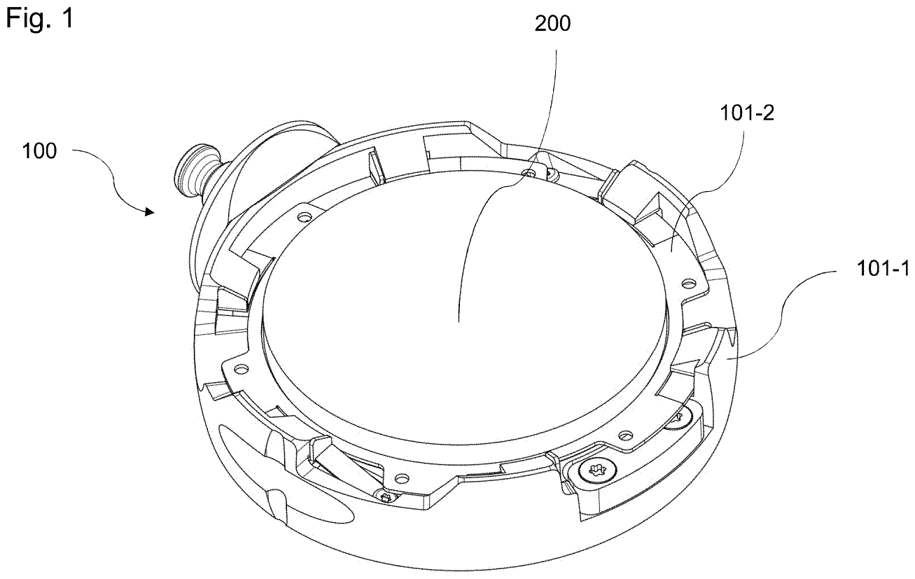

FIG. 1 shows an assembled holding device 100 with a blank 200, a first and a second holding element 101-1 and 101-2. The holding device 100 is used to clamp and hold the blank 200 in a dental milling machine. The holding device 100 with the holding elements 101-1 and 101-2 forms a quick clamping system based on the principle of a bayonet lock. Dental objects, such as crowns or bridges, can be milled from the blank 200 using the dental milling machine.

The holding device 100 can be inserted into the dental milling machine as a quick-clamping system in a modular fashion. However, the holding device 100 can also be used directly in the dental milling machine, in which the first holding element 101-1 is an integral part of the dental milling machine and does not need to be changed.

Incorrect insertion of the blank 200, such as interchanging of the top and bottom surfaces, can be prevented by shaping the blank 200 and the holding elements 101-1 and 101-2 accordingly. In the holding device 100, a clamping force is generated on the blank 200 by means of a rotation of a spring ring through opposing undercuts. The ring 103 may be formed as a spring ring. This allows the blank 200 to be stably fixed between the holding elements 101-1 and 101-2. This takes place in interaction with a bayonet-type locking mechanism.

The holding device 100 does not require screw threads for fastening screws, which are often damaged or loosened thread inserts during use. Therefore, clamping the blank 200 in the holding device 100 does not require torque wrenches or fastening screws that can be lost, damaged, or worn. The clamping force on the blank 200 no longer depends on the proper use of a torque wrench when tightening fastening screws. In addition, the holding device 100 is compatible with changer systems.

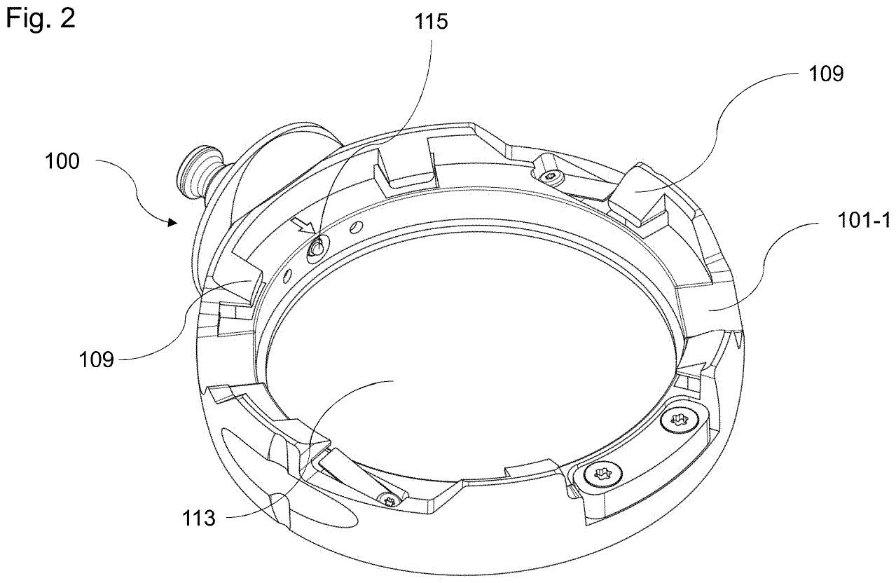

FIG. 2 shows a view of the first holding element 101-1 of the holding device 100. The holding element 101-1 is ring-shaped. The blank 200 is inserted and received in the interior of the holding element 101-1. For this purpose, the first holding element 101-1 comprises a cylindrical workpiece receptacle 113 for inserting the disk-shaped blank 200.

The blank 200 is inserted into the holding element 101-1 with the correct side facing upwards. A ball thrust piece 115 protrudes into the interior of the holding device 100, and the blank 200 engages the ball thrust piece 115. The ball thrust piece 115 can engage in a matching groove or hole 201 on the outside of the blank 200, thereby positioning the blank 200. To do this, the user rotates the blank in the holding element 101-1 until the ball thrust piece 115 engages in the groove in the blank 200. An audible engagement sound is produced here as the blank 200 is rotated to the correct position.

When using a blank 200 without this hole or groove 201, the thrust piece 115 springs into place and is received in the first holding element 101-1. This can ensure compatibility with other blanks. Suitable adapter pieces can be used for other blanks 200.

The user now places the ring 103 in the holding element 101-1. Several pocket-shaped undercuts 109 are arranged on the upper side of the holding element 101-1. These undercuts 109 may be spring-mounted. The circularly arranged undercuts 109 are variable in number and shape. The undercuts 109 serve to support the ring 103 as the second holding element 101-1.

Subsequent rotation of the ring 103 by approximately 45° generates the desired clamping force on the blank 200. However, the angle of rotation can generally be selected differently. The clamped blank 200 is now ready for direct use in the dental milling unit in the holding device 100. Depending on the clamping force, the ring 103 can be rotated manually with the hands or by means of an auxiliary tool. The holding device 100 saves several minutes per material change without having to tighten or loosen fastening screws.

The holding elements 101-1 and 101-2 can be designed for injection molding, so that this can be produced with little effort, such as by metal casting or plastic injection molding. The holding element 101-1 may also be designed as a fiberglass-reinforced component. In this case, radio waves from an RFID chip can pass through the component disposed in the holding element 101-1. In this way, the holding element 100 can be marked by means of an RFID chip or other chip, and the RFID chip can be read through the holding element 100.

The undercuts 109 can also fix the second holding element 101-1 to the first holding element 101-1 by means of a frictional connection. For example, the undercuts 109 may be resiliently mounted and fixed together by means of a lever. In this way, the second holding element 101-1 can be clamped to the first holding element 101-1.

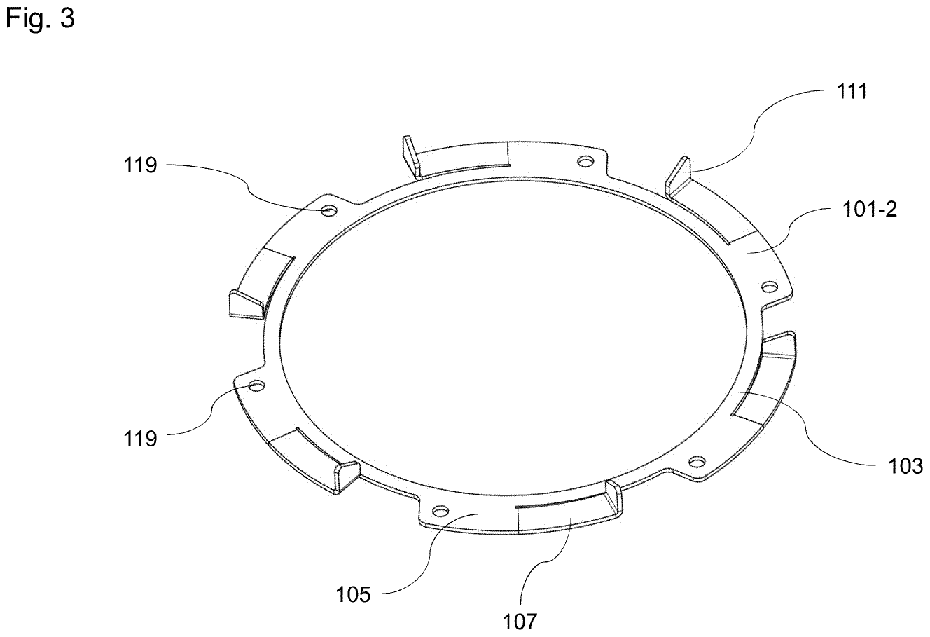

FIG. 3 shows a view of the second holding element 101-2 of the holding device 100. The second holding element 101-2 is formed by a flat and round ring 103. Through the ring 103, a clamping force is exerted on the blank 200 in the direction of the first holding element 101-1. If high clamping forces are required, an auxiliary tool can be used to lock and unlock the ring 103.

The ring 103 includes radially projecting guide sections 105 that extend outward in a star shape. The guide sections 105 form circularly arranged, pre-bent contours. The guide sections 105 enable a preload to be created between the first holding element 101-1, the second holding element 101-2 and the blank 200 by means of a rotation in interaction with the opposing undercuts 109.

As a spring element, the guide sections 105 each comprise a spring section 107 for generating a clamping force on the blank 200 in the direction of the first holding element 101-1. The spring sections 107 in turn comprise a bent stop element 111 for limiting the rotational movement. Generally, the spring element may also be formed by another resilient element that exerts a force in the axial direction on the holding element 101-1, such as a coil spring or a detent spring. In this way, the blank 200 can be clamped between the holding elements 101-1 and 101-2.

The ring 103 can be of closed or open design, for example if it has a radial slot. The variable design of the ring 103 in terms of a shape, an angle, a material thickness and grade means that the clamping force on the blank 200 can be adapted, since different blanks 200 require different clamping forces. The clamping force on the blank 200 can be variably adjusted using different rings 103, such as separate rings 103 made of zirconium or metal. The ring 103 can be formed by a laser or sheet metal bending part.

The ring 103 includes a plurality of holes 119 around its circumference. The holes 119 allow engagement of an auxiliary tool to open the ring 103. For this purpose, grooves may also be arranged in the ring 103 in which the auxiliary tool can engage.

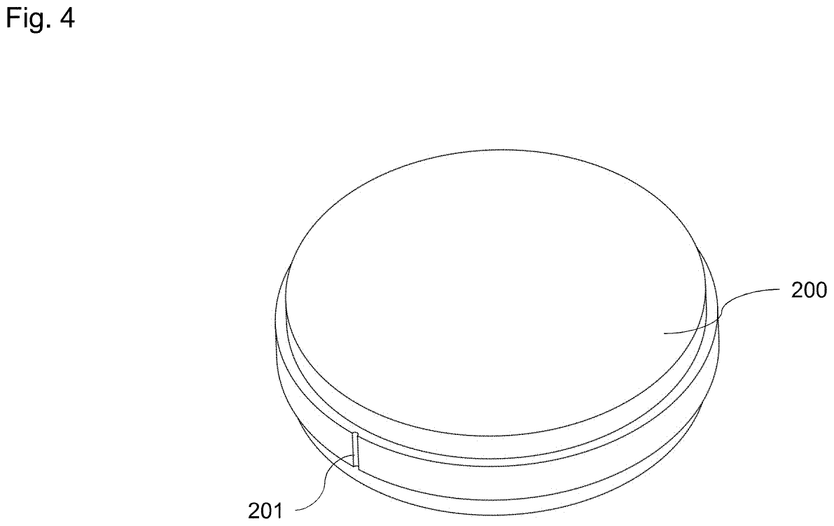

FIG. 4 shows a view of a blank 200. The blank 200 is circular and disc-shaped. However, other shapes of the blank 200 are generally possible, such as rectangular or hexagonal. The blank 200 includes a groove 201 into which the ball thrust piece 115 of the first holding element 101-1 engages, such that a unique position of the blank 200 within the holding device 100 is indicated.

To enable opening of the holding device 100, the guide sections 105 may extend over the undercuts 109. In this case, the holding device 100 can be carried out by hand or by means of the auxiliary tool 200. An undercut 109 with a long configuration enables locking by means of an open ring 103.

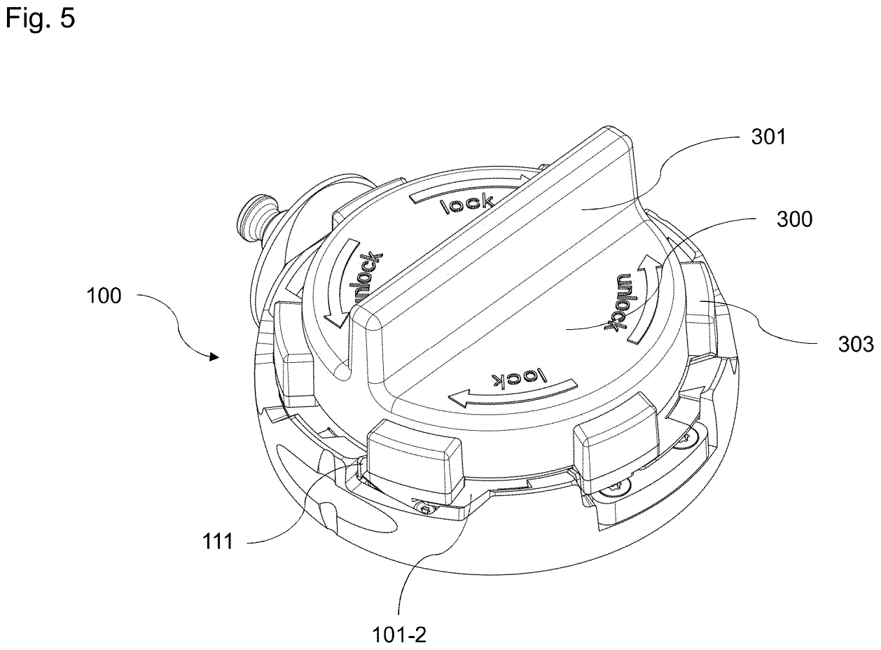

FIG. 5 shows a holding device 100 with an auxiliary tool 300 for opening the holding device 100. The auxiliary tool 300 includes a handle 301 through which the auxiliary tool 300 can be manually rotated. Pins 303 are arranged around the auxiliary tool 300, which, when the auxiliary tool 300 is placed on the holding device 100, penetrate the holes 119 or grooves of the second holding element 101-1. In this way, a torque can be applied to the second holding element 101-2 by means of the auxiliary tool 300 to fasten or loosen it to the first holding element 101-1.

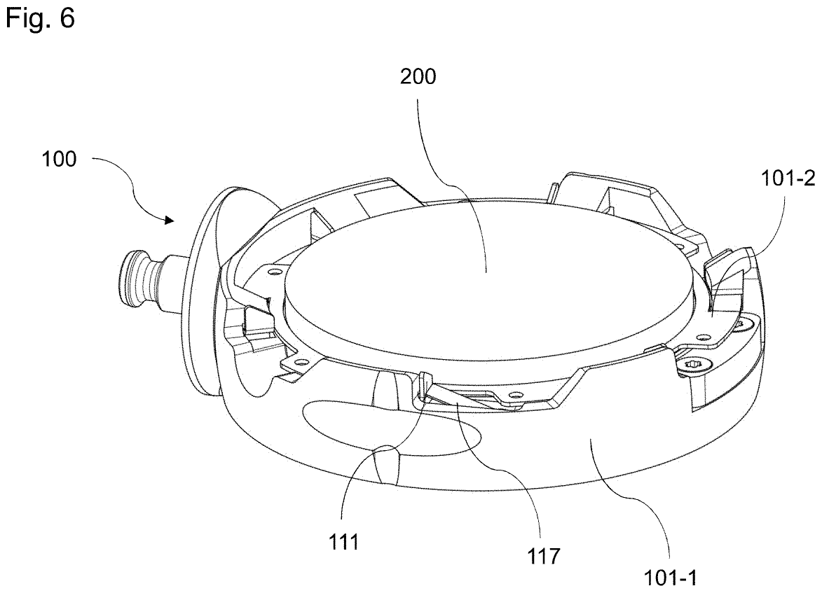

FIG. 6 shows another view of the holding device 100 with a locking element 117. The ring 103 is locked by the locking element 117. The locking element 117 is movably mounted on the first holding element 101-1 and is supported on the stop element 111 of the second holding element 101-2. This prevents the ring 103 from coming loose. The ring 103 is only released when the locking element 117 is pressed down.

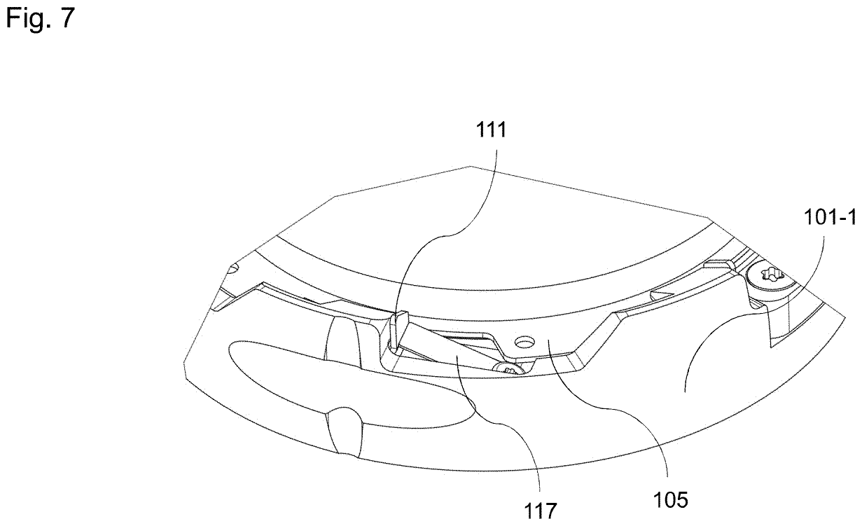

FIG. 7 shows a secondary locking mechanism of the holding device 100. In the event of high torques on the blank 200 due to the machining forces in the dental milling machine, unlocking can be prevented by a secondary locking mechanism. The secondary locking includes the resilient locking element 117 that springs upward when the ring 103 locks in the closed position.

The lever-like locking element 117 is rotatably arranged on the first holding element 101-1 and, in the locked state, is supported on the stop element 111 of the second holding element 101-2. The locking element 117 thereby prevents a vibration from releasing the ring 103 during milling. When unlocked, the locking element 117 is pressed down by corresponding pins of the auxiliary tool 300, thereby releasing it. In this position, the second holding element 101-2 can be rotated.

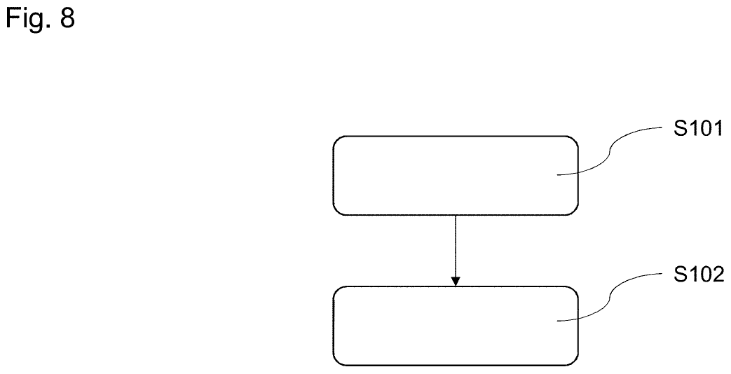

FIG. 8 shows a block diagram of a method for holding the blank 200. In step 5101, the blank 200 is inserted into the first holding element 101-1. In step 5102, the blank 200 is clamped in the holding device 100 by a rotational movement of the second holding element 101-2, which is lockable to the first holding element 101-1. Thus, a stable fixation of the blank 200 between the two holding elements 1011 -and 101-2 is achieved.

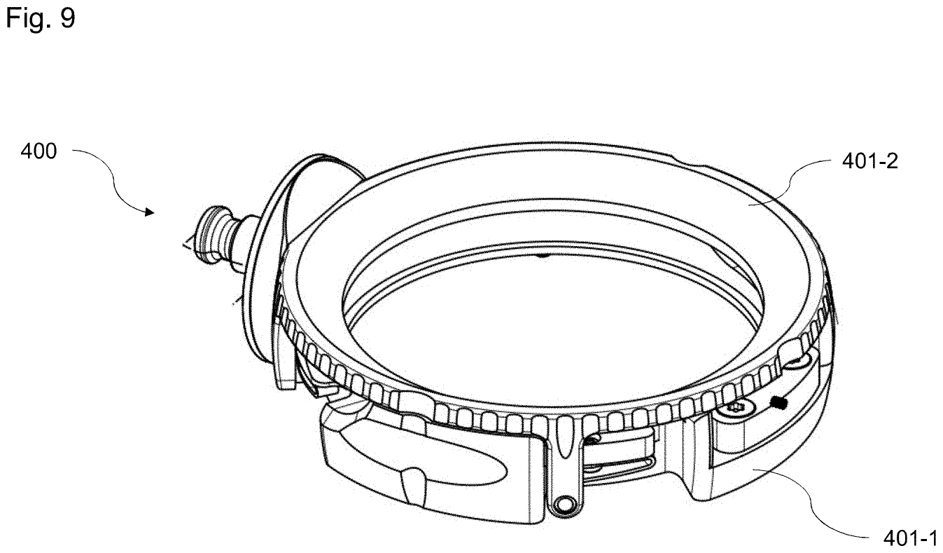

FIG. 9 shows a further embodiment of the holding device 400. The holding device 400 also comprises a first holding element 401-1 and a second holding element 401-2. The second holding element 401-2 also serves to clamp the blank 200 and can be locked to the first holding element 401-1 by a rotary movement. The blank 200 is thereby also clamped between the two holding elements 401-1 and 401-2.

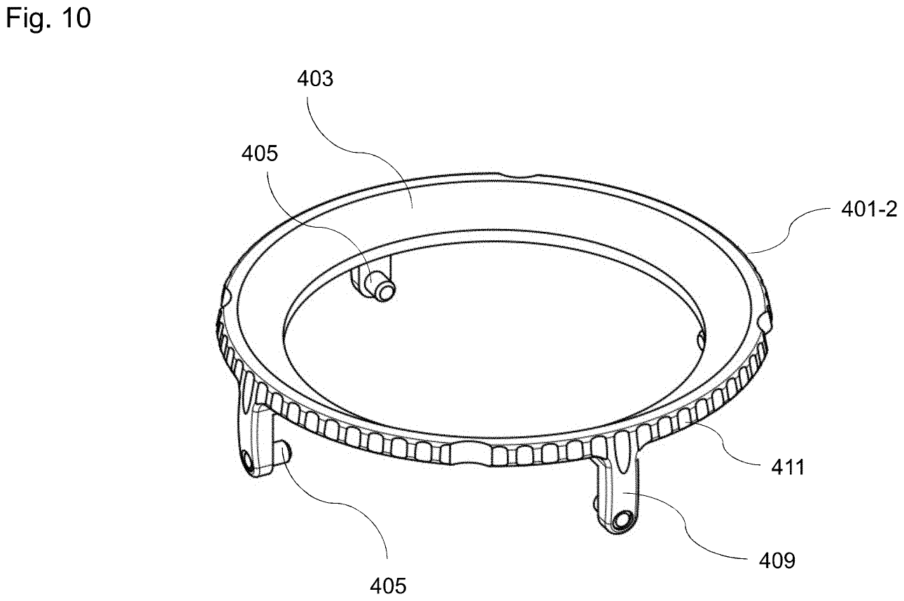

FIG. 10 shows a view of the second holding element 401-2 of the holding device 400. The second holding element 401-2 is also formed by a ring 403. On the underside of the ring 403 are a plurality of rod-like arms 409, extending in the axial direction of the ring 403. The arms 409 extend from the ring 403 in the perpendicular direction. On the outer circumferential side of the ring 403, there are a plurality of indentations 411 that create a grip profile and facilitate rotation of the ring 403.

At the tip of the arms 409 are pin-shaped guide sections 405, which in turn extend radially inward toward the center of the ring 403. The guide sections 405 engage with the first holding element 401-1 so that the two holding elements 401-1 and 401-2 can be locked with a rotational movement and a retaining tension can be applied to the blank.

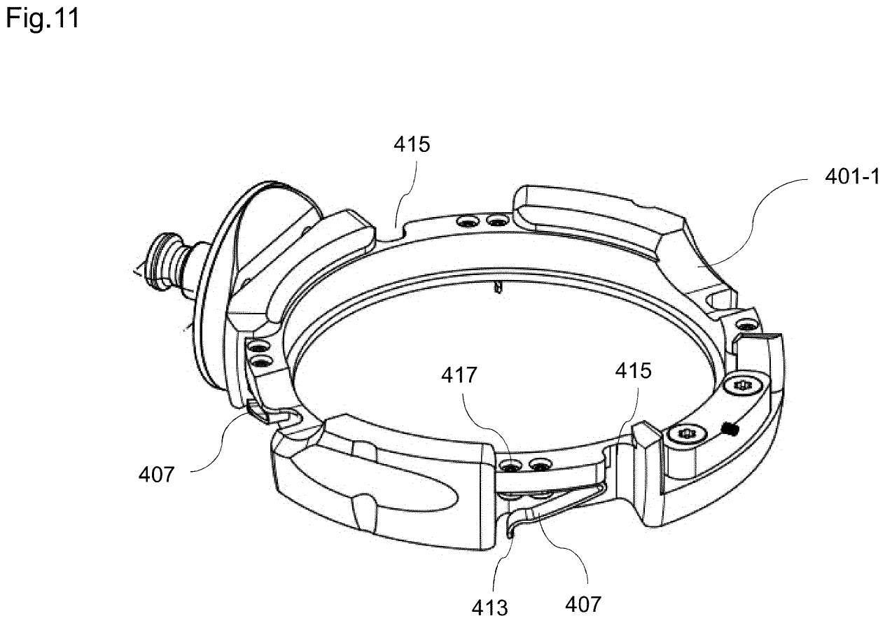

FIG. 11 shows a view of the first holding element 401-1 of the holding device 400. The first holding element 401-1 includes a plurality of spring elements 407 for exerting a clamping force on the guide sections 405 of the second holding element 401-2. The spring elements 407 press the first and second holding elements 401-1 and 401-2 against the blank 200. The spring elements 407 are formed by v-shaped leaf springs arranged on the bottom surface of the first holding element 401-1. One wing of the v-shaped leaf springs rests against the underside of the annular holding element 401-1. When closed, the underside faces away from the second holding element 401-2. This wing may be attached to the annular holding element 401-1 by screws or bolts 417.

The other wing of the V-shaped leaf springs protrudes resiliently in the axial direction and includes a trough 413 in which guide sections 405 engage in the closed state. On the outer circumferential side of the first holding element 401-1 are a plurality of radial recesses 415, the number of which corresponds to the number of arms of the second holding element 401-2. When the holding elements 401-1 and 401-2 are assembled, the guide sections 405 of the second holding element 401-2 are first guided through the recesses 415 in the axial direction. Then the holding elements 401-1 and 401-2 are rotated against each other. In the process, the guide sections 405 slide over the protruding wing of the leaf springs, which exerts an increasing, compressing axial force on the second holding element 401-2. In the stop position, the guide sections 405 engage the trough 413 and clamp the blank. Generally, the spring element 407 may also be formed by another resilient element that exerts a force in the axial direction on the holding element 401-2, such as a coil spring or a detent spring. In this way, the blank 200 can be clamped between the holding elements 401-1 and 401-2.

All features explained and shown in connection with individual embodiments of the invention may be provided in different combinations in the subject matter of the invention to simultaneously realize their beneficial effects.

All method steps can be implemented by means suitable for executing the respective method step. All functions that are executed by the features can be a process step of a method.

The scope of protection of the present invention is given by the claims and is not limited by the features explained in the description or shown in the figures.

### REFERENCE LIST

100 Holding device or holder
101 Holding element
103 Ring
105 Guide section
107 Spring section
109 Undercut
111 Stop element
113 Workpiece receptacle
115 Ball thrust piece
117 Locking element
119 Hole
200 Blank
201 Groove
300 Auxiliary tool
301 Handle
303 Pins
400 Holding device
401 Holding element
403 Ring
405 Guide section
407 Spring element
409 Arm
411 Indentations
413 Trough

1. A holder (100) for a blank (200), comprising:
a first holding element (101-1, 401-1) for inserting the blank (200); and
a second holding element (101-2, 401-2) for clamping the blank (200), which is lockable to the first holding element (101-1, 401-1) by a rotary movement.

2. The holder (100) according to claim 1, wherein the second holding element (101-2) is formed by an open or closed ring (103, 403).

3. The holder (100) according to claim 2, wherein the holding element (101-1, 401-1) comprises radially inwardly or outwardly projecting guide sections (105, 405).

4. The holder (100) according to claim 3, wherein the guide sections (105, 405) are arranged on arms (409) extending in the axial direction of the second holding element (101-2, 401-2).

5. The holder (100) according to claim 3, wherein the radially protruding guide sections (105) each comprise a spring portion (107) for generating a clamping force on the blank (200) in the direction of the first holding element (101-1).

6. The holder (100) according to claim 5, wherein the first or second holding element (101-1, 401-1, 101-2, 401-2) comprises a stop element (111) for limiting the rotational movement.

7. The holder (100) according to claim 4, wherein the first holding element (401-1) comprises at least one spring element (407) for exerting a clamping force on a guide section (405) of the second holding element (401-2), or the second holding element (101-2) comprises at least one spring element (107) for exerting a clamping force on a guide section (105) of the first holding element (101-1).

8. The holder (100) according to claim 7, wherein the spring element (407) is formed by a leaf spring.

9. The holder (100) according to claim 7, wherein the first or second holding element (401-1, 401-2) comprises at least one recess (415) for passing the guide section (405) therethrough.

10. The holder according to claim 7, wherein one side of a v-shaped leaf spring abuts the first holding element (401-1).

11. The holder (100) according to claim 7, wherein the spring elements (407) are arranged on a side of the first holding element (401-1) facing away from the second holding element (401-2).

12. An auxiliary tool (300) for opening the holder (100) according to claim 1, comprising at least one engagement element for engaging a hole or groove of the second holding element (101-2).

13. A process of holding a blank (200), comprising:
inserting (S101) the blank (200) into a first holding element (101-1, 401-1); and
clamping (S102) of the blank (200) by a rotational movement of a second holding element (101-2, 401-2) lockable to the first holding element (101-1, 401-1).

14. The process according to claim 13, wherein a clamping force is generated on the blank (200) in the direction of the first holding element (101-1).

15. The process according to claim 13, wherein spring portions (107, 407) of the second holding element (101-2, 401-2) are supported on undercuts (109, 415) of the first holding element (101-1) or radially inwardly or outwardly projecting guide sections (405) of the first or second holding element (401-2) are supported on spring elements (407) of the first or second holding element (401-1).
